(19) United States
(12) Patent Application Publication
(10) Pub. No.: US 2014/0231296 A1
(43) Pub. Date: Aug. 21, 2014

(54) SINGLE-DOSE SEALED PACK WITH BREAK OPENING AND METHOD FOR THE MANUFACTURE OF A SINGLE-DOSE SEALED PACK WITH BREAK OPENING

(71) Applicant: MEPAR SOCIETA'A RESPONSABILITA' LIMITATA, Torino (IT)

(72) Inventor: Bruno Reggio, Canelli (AT) (IT)

(21) Appl. No.: 14/351,411

(22) PCT Filed: Oct. 10, 2012
(86) PCT No.: PCT/IB2012/002015

§ 371 Date: Apr. 11, 2014

(30) Foreign Application Priority Data
Oct. 11, 2011 (IT) MO2011A000258

(51) Int. Cl. B65D 83/00; B32B 38/00

(52) U.S. Cl. CPC B65D 83/00; B32B 38/0004
USPC 206/484; 156/257

(57) ABSTRACT

The single-dose sealed pack (1) with break opening includes a first sheet (2) made of semi-rigid plastic material, a second sheet (3) made of flexible plastic material associated with the first sheet (2) to define a sealed containment chamber for containing at least a dose of a product, wherein on a face (2a) of the first sheet are defined at least a pair of first cuts (4) spaced out from each other and on the opposite face (2b) is defined at least a second cut (5) arranged in correspondence to the area (6) between the first cuts (4), so as to determine a substantially sudden breakage of the first sheet itself in correspondence to the area (6) between the first cuts (4) and such to substantially involve the entire extension of the second cut (5).

### TECHNICAL FIELD

The present invention relates to a single-dose sealed pack with break opening and a method for the manufacture of a single-dose sealed pack with break opening.

### BACKGROUND ART

As is known, single-dose packs with break opening are made up of a sheet of semi-rigid plastic material superimposed and sealed on a sheet of flexible plastic material so as to define a sealed containment chamber containing a dose of liquid product. Generally, the sheet of semi-rigid material has a central pre-cut which facilitates and guides the subsequent breakage.

WO 2008/038074 and WO 2009/040629 describe various embodiments of single-dose packs, wherein the cut defined on the semi-rigid sheet has a variable depth along its length so as to allow the controlled and gradual opening of the pack itself.

This cut can be obtained on just one of the faces of the semi-rigid sheet or on both faces.

The semi-rigid sheet is generally composed of an outer bearing layer, of an intermediate barrier layer and of a heat-sealable inner layer.

According to WO 2009/040629, the pre-cut defined on the semi-rigid sheet is obtained by pressing the semi-rigid sheet itself between two cutting elements so as to locally deform all three layers in correspondence to the inner side of the sheet itself.

These packs of known type do have some drawbacks.

In fact, unlike what could intuitively be expected, the controlled and gradual opening of the known packs, obtained by means of the variable-depth pre-cut described above, involves uncontrolled and sudden product dispensing.

This drawback is due to the fact that during pack opening, the pressure of the liquid product contained inside it rises by effect of the deformation of the pack itself and, because the gap which is initially defined on the first sheet is small in size, the pressure inside the product containment chamber is considerably higher than outside pressure, giving rise to the irregular dispensing of the product itself.

Another drawback of packs of known type consists in the fact that the gradual breakage of the semi-rigid sheet results in the edges of the opening thus obtained being irregular and frayed, and such as to divert in an uncontrolled way the flow of exiting product.

Yet another drawback consists in the fact that the local deformation caused by the pre-cut can cause the undesired breakage of the barrier layer, generally of very small thickness, with the consequent risk of the contained product coming into contact with the bearing layer, damaging it and then exiting on the outside.

Because the layers making up the semi-rigid sheet generally have different elasticity degree, the breakage or deformation of the barrier layer may also be necessary to ensure the breakage of the layer with greater elasticity degree, i.e., to prevent the more elastic layer from bending only, making it hard to open the pack without strongly squeezing it.

Yet another drawback of sealed packs of known type consists in the fact that the local deformation of all the layers making up the semi-rigid sheet can lead to their partial fusion and to an alteration of their state, with the consequent risk of chemical migration of the deformed or broken layers towards the inside of the containment chamber.

The document WO 2007/145535 describes a bag made up of three superimposed sheets, of which a first flexible sheet, a second semi-rigid sheet and a third sheet, this too flexible and shaped so as to define a containment tray for the product to be dispensed.

The semi-rigid sheet has at least one cut, which can partially or totally cross the thickness thereof, shaped in such a way as not to define a 180° angle, so as to give rise, following the fracture of the semi-rigid sheet itself, to one or more V-shaped breakage lines. The shape of such breakage lines, which therefore follow the profile of the cut made on the semi-rigid sheet, is of crucial importance inasmuch as it allows applying a mechanical action such as to then cause the breakage of the outer flexible sheet, thus making the contents of the pack accessible. More in particular, the indentations designed by the geometry of the cut defined on the semi-rigid sheet move away from one another following the folding of the pack, stretching and perforating the flexible sheet.

The outer flexible sheet therefore acts so as to ensure the contents of the pack do not accidentally come out of this including in the case of the accidental breakage of the barrier layer defined in the semi-rigid sheet. The outer flexible sheet is therefore meant to break in the area arranged in correspondence to the cut made on the underlying semi-rigid sheet.

The outer sheet can also have one or more cuts, which define a number of preferential folding lines, which must be arranged in such a way as not to be superimposed on the cut obtained on the semi-rigid sheet to prevent accidental liquid leaks. In this case, the cuts turned towards the outside of the pack and those turned towards the inside are defined on two different sheets.

The pack described by WO 2007/145535 also has drawbacks however.

It is in fact complex from both a construction and a functional viewpoint.

More in particular, the outer flexible sheet is very hard to lacerate upon folding the pack. This is due to the high elasticity degree distinguishing the outer sheet and to the fact that such task is left to the sole mechanical action of the semi-rigid sheet.

It follows therefore, that to ensure the breakage of the outer sheet, the semi-rigid sheet must not be very flexible and must be particularly thick and this, at the same time, involves a high risk of accidental breakage of same.

Again, the non-rectilinear cut on the semi-rigid sheet is not easy to achieve.

A further drawback consists in the fact that any cuts made on the outer flexible sheet must not be superimposed on that defined on the semi-rigid sheet in order to prevent the accidental leakage of the contents in the event of the barrier layer being damaged or involved in the cut itself.

This translates into less manufacturing flexibility and, consequently, into greater production difficulty and higher cost of the finished product.

### DESCRIPTION OF THE INVENTION

The main aim of the present invention is to provide a single-dose sealed pack which allows obtaining the gradual and controlled exit of the product contained in it.

Within this aim, one object of the present invention is to prevent, including following the breakage of the semi-rigid sheet, any big pressure difference between the inside and the outside of the containment chamber.

One object of the present invention is to obtain a smooth edge of the opening defined following the breakage of the semi-rigid sheet so as to prevent undesired diversions of the product flow.

Another object of the present invention is to provide a geometry of the opening system which allows reducing the thickness of the semi-rigid film and/or increasing the safety margins for the packs and for the operators.

In particular, one object of the present invention is to considerably curtail the risk, compared to packs of known type, of the pre-cut defined in correspondence to the inner face of the semi-rigid sheet damaging the barrier layer and causing its undesired breakage.

Yet another object of the present invention is to prevent the occurrence of the chemical migration phenomena of the layers making up the semi-rigid sheet with the possible risk of contamination of the contained product.

Another object of the present invention is to provide a single-dose sealed pack with break opening that allows to overcome the mentioned drawbacks of the background art in the ambit of a simple, rational, easy, effective to use and low cost solution.

The above objects are achieved by the present single-dose sealed pack with break opening and comprising:
a first sheet made of semi-rigid plastic material;
a second sheet made of flexible plastic material associated with said first sheet to define a sealed containment chamber for containing at least a dose of a product;
at least a cut defined on said first sheet to guide the breakage of the first sheet itself so as to determine the formation of an opening for the exit of the product;

characterized by the fact that it comprises at least a pair of first cuts defined on a face of said first sheet and spaced out from each other and at least a second cut defined on the opposite face of the first sheet itself in correspondence to the area between said first cuts, so as to determine a substantially sudden breakage of said first sheet in correspondence to said area between the first cuts and such to substantially involve the entire extension of said second cut.

### BRIEF DESCRIPTION OF THE DRAWINGS

Other characteristics and advantages of the present invention will become more evident from the description of a preferred, but not sole, embodiment of a single-dose sealed pack with break opening and a method for the manufacture of a single-dose sealed pack, illustrated purely as an example but not limited to the annexed drawings in which:

FIG. 1 is an axonometric view of a pack according to the invention;

FIG. 2 is a plan bottom view of the pack of FIG. 1;

FIG. 3a is a section along the cuts of the first sheet of the pack of FIG. 2;

FIG. 3b is a section along the cuts of an alternative embodiment of the first sheet of a pack according to the invention;

FIG. 4 is a section view of the first sheet of the pack of FIG. 2 along a plane transversal to one of the first cuts, in a first embodiment;

FIG. 5 is a section view of the first sheet of the pack of FIG. 2 along a plane transversal to the second cut, in the first embodiment;

FIG. 6 is a section view of the first sheet of the pack of FIG. 2 along a plane transversal to one of the first cuts, in a second embodiment;

FIG. 7 is a section view of the first sheet of the pack of FIG. 2 along a plane transversal to the second cut, in the second embodiment;

FIG. 8 is a schematic representation of the manufacturing phase of the first sheet of semi-rigid plastic material of the method according to the invention.

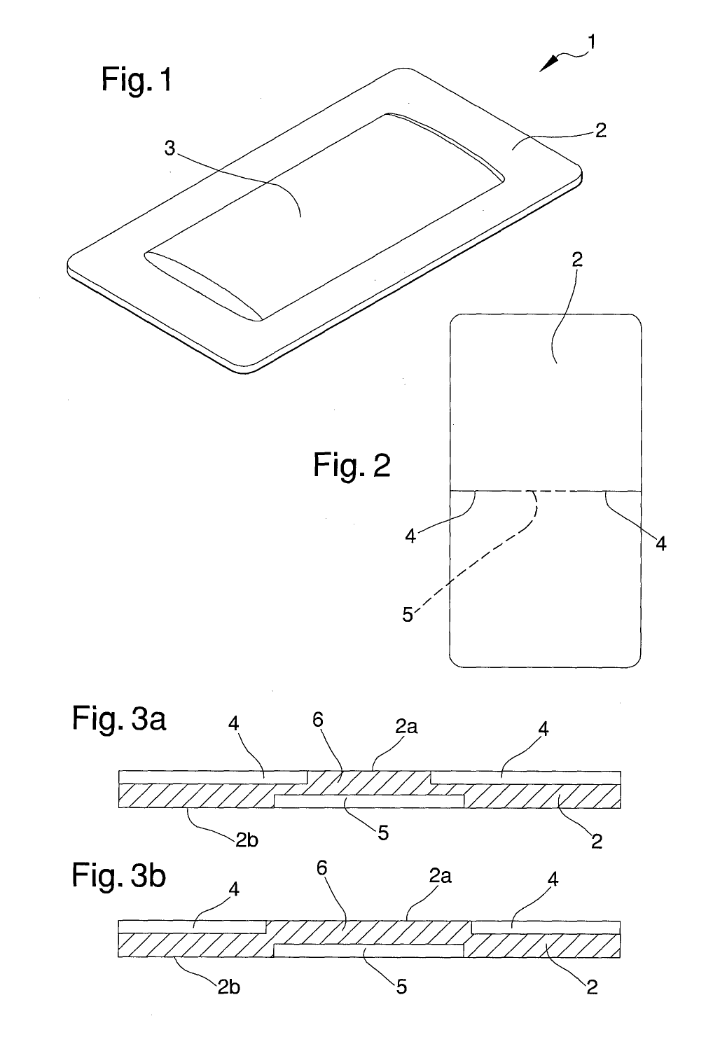

### EMBODIMENTS OF THE INVENTION

With particular reference to such figures, globally indicated by 1 is a single-dose sealed pack with break opening.

The pack 1 comprises a first sheet 2 of semi-rigid plastic material and a second sheet 3 of flexible plastic material associated with the first sheet 2, generally by means of hot sealing, to define a sealed containment chamber for containing a dose of a liquid product.

The pack 1 then comprises at least one cut 4,5 defined on the first sheet 2 to guide the breakage of the first sheet itself so as to determine the formation of an opening for the exit of product.

According to the invention, the pack 1 comprises at least a pair of first cuts 4 defined on a face 2a of the first sheet 2 and spaced out from each other, where the area of the face 2a between such first cuts 4 is indicated in the illustrations by the reference number 6, and at least a second cut 5 defined on the opposite face 2b of the first sheet itself in correspondence to the area 6 (i.e., in the surrounding area of the face 2b facing the area 6), so as to determine a breakage of the first sheet 2 in correspondence to the area 6 between the first cuts 4 and such as to suddenly substantially affect all or nearly all (depending on the depth and the length of the cuts 4 and 5) the extension of the second cut 5. The breakage which occurs following the deformation of the first sheet 2 is not therefore gradual, but rather a sudden breakage which involves at the same time, all or nearly all the length of the second cut 5.

The area 6 defined on the face 2a is integral (before the deformation of the first sheet 2), i.e., without cuts.

More in particular, the first sheet 2 has three portions adjacent to one another which intercept both the faces 2a and 2b, including two side portions and one central portion placed between the side portions, where the first cuts 4 are defined at least in correspondence to the two side portions and are spaced out the one from the other in correspondence to the central portion and where the second cut 5 is defined at least in correspondence to the central portion.

In the embodiment shown in the illustrations, the cuts 4 and 5 are substantially straight (excepting the working tolerances), but alternative embodiments cannot be ruled out wherein the cuts 4 and 5 are curved or V-shaped, U-shaped, etc. . . . Suitably, the first cuts 4 are arranged substantially symmetric with respect to the longitudinal axis of the first sheet 2.

The cuts 4 and 5 extend transversally to the first sheet 2, i.e. substantially parallel to a shorter side of the first sheet itself.

Alternative embodiments cannot however be ruled out, wherein at least one of the cuts 4 and 5 is arranged sloped with respect to the shorter sides of the first sheet 2.

Preferably, the first cuts and the second cut 4 and 5 are longitudinally aligned (where by the term longitudinally is meant the direction defined by their length) and are staggered along the thickness of the first sheet 2.

More in detail, in the embodiment shown in FIG. 3, the first cuts 4 and the second cut 5 are coplanar the one to the other.

The second cut 5 can be partially superimposed on at least one of the first cuts 4, e.g. because it protrudes inside one of the two side portions of the first sheet 2 (or vice versa) as shown in FIG. 3a, or does not have even one section superimposed over one of the two first cuts 4 as shown in FIG. 3b.

Advantageously, the first cuts 4 and the second cut 5 are defined on the outer face and on the inner face of the first sheet 2, respectively.

Because, in order to cause the breakage of the first sheet 2, a bending moment has to be applied to same such as to bring its longitudinal extremities closer on the side of the inner face 2a, it follows that the first cuts 4 give greater elasticity to the side portions of the first sheet itself, thus helping it to bend, and that the area 6 between them is that subject to the effort of major intensity (inasmuch as it represents the extrados of the first sheet 2). Such area 6 is further weakened by the presence of the second cut 5 on the opposite face 2b and, therefore, it suddenly yields following the deformation of the first sheet 2.

Suitably, at least one between the first cuts 4 and the second cut 5 has substantially constant depth along its length (excepting the invitation required for their realization). Preferably, both the first cuts 4 and the second cut 5 have substantially constant depth along their relative lengths.

More in particular, the first sheet 2 has a thickness between 100 μm and 400 μm in correspondence to the first cuts 4.

The first sheet 2 then has a thickness between 200 μm and 500 μm correspondence to the second cut 5.

Preferably, the first sheet 2 has greater thickness in correspondence to the second cut 5. It follows therefore that the thickness of the first sheet 2 is greatest in correspondence to its area meant to be broken as a result of the deformation of the first sheet itself, in such a way as to reduce the risk of the product contained in the pack 1 accidentally leaking out.

The first sheet 2 is shaped in such a way that its elasticity decreases proceeding from the inside towards the outside (where the terms inside and outside are used here with reference to the chamber which contains the product to be dispensed), i.e., proceeding from the face 2b towards the face 2a. This means, therefore, that the face 2b turned towards the second sheet 3 is more elastic than the face 2a turned outwards.

Because of the arrangement of the cuts 4 and 5 and the shape of the first sheet 2 described herein above, following the folding of the pack 1, the first sheet itself fractures starting with the face 2a turned outwards.

More in detail, the first sheet 2 is of the type of a laminate comprising at least one bearing layer 7 arranged towards the outside, at least one heat-sealable layer 8 arranged towards the inside and at least one barrier layer 9 placed between the bearing layer 7 and the heat-sealable layer 8.

Generally, the bearing layer 7 is made up of one of the following materials: polystyrene (PS), polyvinyl chloride (PVC), acrylonitrile butadiene styrene (ABS), amorphous polyethylene terephthalate (APET), or polypropylene (PP); the heat-sealable layer 8 is made up of one of the following materials: polyethylene (PE) or polypropylene (PP); the barrier layer 9 is made up, e.g., of “Evoh”.

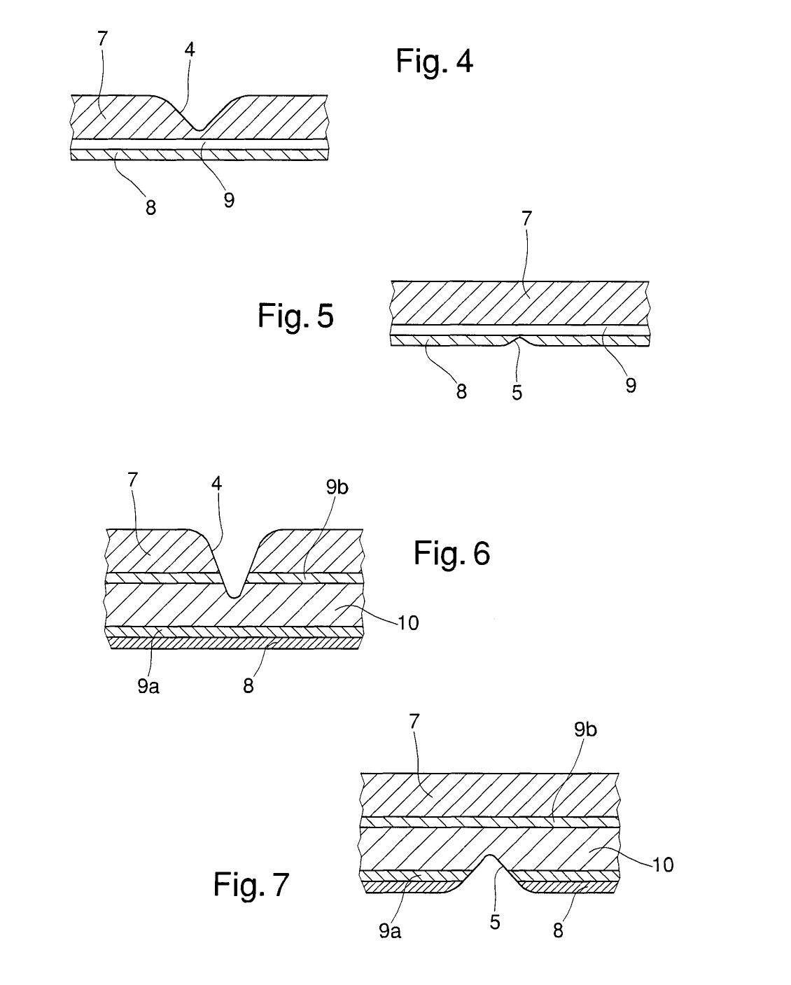

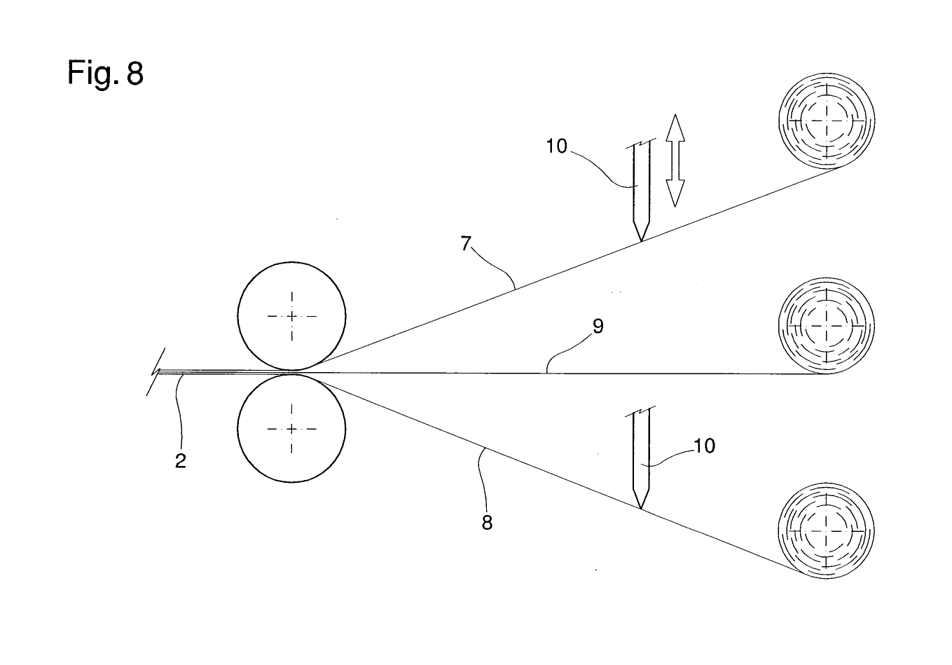

In the first embodiment shown in the FIGS. 4 and 5, the first sheet 2 comprises one bearing layer 7, one heat-sealable layer 8 and one barrier layer 9 placed between the layers 7 and 8.

In this embodiment, preferably, the bearing layer 7 has a thickness between 100 μm and 400 μm, the heat-sealable layer 8 has a thickness between 50 μm and 200 μm and the barrier layer 9 has a thickness between 5 μm and 10 μm.

Advantageously in fact, the second cut 5 is made in such a way as to only involve the heat-sealable layer 8, leaving at least the barrier layer 9 substantially unchanged. More in detail, the second cut 5 is such as to affect all the thickness of the heat-sealable layer 8, defining a through cut.

Suitably, the first cuts 4 too are made in such a way as to only involve the bearing layer 7, leaving at least the barrier layer 9 substantially unchanged.

More in detail, the second cut 5 is such as to involve all the thickness of the bearing layer 7, defining a through cut.

Alternative embodiments cannot however be ruled out wherein the first cuts and the second cut 4 and 5 are such as to define only a local deformation of the layers 7 and 8, without therefore causing breakage or cutting.

The absence of cuts in correspondence to the area 6 and the greater thickness of the first sheet 2 in correspondence to the second cut 5, by suitably changing the thickness of the layers 7, 8 and 9, permit spacing out the barrier layer 9 from the second cut 5 in order to improve the safety of the pack 1 and reduce the risk of accidental breakage of the barrier layer itself.

Alternative embodiments cannot however be ruled out wherein the first sheet 2 also comprises further layers besides those already mentioned.

In particular, in the second embodiment shown in the FIGS. 6 and 7, the first sheet 2, besides the bearing layer 7 and the heat-sealable layer 8 defining the outer face and the inner face of the first sheet itself, also comprise two barrier layers 9, one of which an inner barrier layer 9a and the other an outer barrier layer 9b. Between the barrier layers 9a and 9b is placed at least one intermediate layer 20, preferably made of the same material as the bearing layer 7.

In this second embodiment, the first cuts 4 are defined so as to involve at least the outer barrier layer 9b leaving the inner barrier layer 9a unchanged. Preferably, the first cuts 4 define a relative cut which crosses the bearing layer 7 and the outer barrier layer 9b along their entire thickness, until it arrives in correspondence to the intermediate layer 20.

In the same way, the second cut 5 is also such as to involve at least the inner barrier layer 9a leaving at least the outer barrier layer 9b unchanged. Preferably, the second cut 5 defines a cut which crosses the heat-sealable layer 8 and the inner barrier layer 9a along their entire thickness, until it arrives in correspondence to the intermediate layer 20.

Suitably, the intermediate layer 20 can remain unchanged or, alternatively, can be intercepted only partially by the first cuts and the second cut 4 and 5, which therefore only cross it partially.

Alternative embodiments cannot however be ruled out wherein the first cuts and the second cut 4 and 5 are such as to only define a local deformation of the layers 7, 9b and 8, 9a respectively, without therefore causing their breakage or cutting.

In this embodiment, there is therefore at least one bather layer 9a, 9b placed between the product contained in the pack 1 and the outside, thus ensuring the seal of the pack itself.

For the technician in the sector, it is easy to appreciate how the reciprocal arrangement of the cuts 4 and 5 according to the present invention allows obtaining a breakage of the first sheet 2 located in the area 6 and how such breakage is such as to bring about a quick rebalance of the pressures inside and outside the chamber containing the product, thus allowing the regular dispensing of the product itself.

The present invention also relates to a method for the manufacture of a single-dose sealed pack with break opening of the type described above.

Such method provides, as is known, the supply of at least the bearing layer 7, the heat-sealable layer 8 and the barrier layer 9, or of the barrier layers 9a and 9b. The layers 7, 8 and 9 are for example supplied in reel form.

The method according to the invention comprises at least one local cut phase of at least one of the layers 7, 8 and 9 to define at least one cut 4,5 suitable for guiding the breakage of the first sheet itself so as to determine an opening to allow the product to come out.

More in particular, the cut phase comprises:
a first cutting phase of the bearing layer 7 only, so as to define two first through cuts 4 in correspondence to the side portions of the bearing layer itself, spaced out from one another in correspondence to the central portion placed between the above-mentioned side portions;
at least a second cutting phase of the heat-sealable layer 8 only, so as to define at least one second through cut 5 in correspondence to the central portion of the heat-sealable layer itself.

These cutting phases can be performed using suitable cutting means 10 which contact just one or both the faces of the relative layer 7,8.

The first and the second cutting phases involve the bearing layer 7 and the heat-sealable layer 8 respectively. The barrier layer 9, instead, does not undergo any local deformation phase and remains therefore unchanged.

Alternative embodiments of the cutting phase of the layers 7 and 8 cannot however be ruled out, such as to locally deform these without causing them to be cut or broken. In this case, during the subsequent solidarization phase, the barrier layer 9, by being pressed against the other two layers 7 and 8, can also be deformed, following the profile of the bearing layer 7 and of the heat-sealable layer 8 with which it is in contact. This deformation, which can occur during the reciprocal solidarization phase of the various layers does not in any case bring about the definition of any cut on the barrier layer 9 (which is not therefore weakened) but only the superficial adaptation of its profile in accordance with that of the adjacent layers, in such a way as to maintain the adherence between the layers themselves making up the first sheet 2.

For the technician in the sector, the application of the method according to the invention to obtain a pack in the second embodiment described above becomes immediately appreciable. More in particular, in this case, the cutting phase will also comprise further cutting or local deformation phases, including of the outer barrier layer 9b and of the inner barrier layer 9a to obtain the first cuts and the second cut 4 and 5.

After the cutting phases, a reciprocal solidarization phase is performed of the various layers 7, 8, 9 so as to obtain a semi-rigid first sheet 2. More in detail, such solidarization phase is performed in such a way that the central portion of the heat-sealable layer 8 is arranged in correspondence to the central portion of the bearing layer 7. Furthermore, the layers 7 and 8 are superimposed on one another in such a way that the cuts 4 and 5 defined on them are substantially aligned the one with the other.

At the end of the solidarization phase of the layers 7, 8, 9 a further solidarization phase is performed of a second sheet 3 flexible to the semi-rigid first sheet 2 thus obtained, so as to define a sealed containment chamber for containing a dose of product.

According to ways known to the technician in the sector, a filling phase of the chamber with the product of interest is also suitably performed.

It has in fact been ascertained how the described invention achieves the proposed objects and in particular the fact is underlined that the particular arrangement of the cuts defined on the two faces of the semi-rigid first sheet permits obtaining a clean and immediate breakage of same, thus favouring the natural balance of the pressures inside and outside the pack itself and consequently the smooth outflow of the product.

At the same time, the pack according to the invention is safer than those known to date, inasmuch as the greater thickness of the first sheet in the area intended to break allows reducing the risk of breakage of the barrier layer and therefore the accidental outflow of the product. More in particular, the fact that the first cuts and the second cut are staggered with respect to each other along the thickness of the first sheet allows adjusting as required the position of the barrier layer with respect to the inner cut, so as to increase the safety of the pack thus obtained.

It is therefore pointed out how the solution forming the subject of the present invention allows, cutting depth being equal, obtaining a greater thickness of integral material compared to packs of known type. Such thickness can be reduced in order to reduce the total thickness of the semi-rigid sheet and therefore also the cost of manufacture, or can remain to ensure a safer pack seal or allow a greater operating margin during the making of the cuts.

Again, the method according to the invention allows making the cuts in a more precise way compared to known methods and, therefore, avoiding the barrier layer being accidentally damaged by the cutting means.

Furthermore, the method in question allows reducing the thicknesses of the layers making up the first sheet, thus obtaining a more economical pack and one with less environmental impact.

1-14. (canceled)

15. Single-dose sealed pack (1) with break opening and comprising:
a first sheet (2) made of semi-rigid plastic material;
a second sheet (3) made of flexible plastic material associated with said first sheet (2) to define a sealed containment chamber for containing at least a dose of a product;
at least a cut (4, 5) defined on said first sheet (2) to guide the breakage of the first sheet itself so as to determine the formation of an opening for the exit of the product;
wherein it comprises at least a pair of first cuts (4) defined on a face (2a) of said first sheet (2) and spaced out from each other and at least a second cut (5) defined on the opposite face (2b) of the first sheet itself in correspondence to the area (6) between said first cuts (4), so as to determine a substantially sudden breakage of said first sheet (2) in correspondence to said area (6) between the first cuts (4) and such to substantially involve the entire extension of said second cut (5).

16. A pack (1) according to claim 15, wherein said first cuts (4) are defined in correspondence to a respective side portion of said first sheet and are spaced out in correspondence to its central portion and by the fact that said second cut is defined in correspondence to the central portion itself.

17. A pack (1) according to claim 15, wherein said cuts (4, 5) are substantially straight.

18. A pack (1) according to claim 15, wherein said cuts (4, 5) are substantially coplanar the one to the other.

19. A pack (1) according to claim 15, wherein said second cut (5) is partially superimposed over at least one of said first cuts (4).

20. A pack (1) according to claim 15, wherein said first cuts (4) and said second cut (5) are defined on the outer face (2a) and on the inner face (2b) of said first sheet (2), respectively.

21. A pack (1) according to claim 15, wherein at least one between said first cuts and second cut (4, 5) has a substantially constant depth along its own length.

22. A pack (1) according to claim 15, wherein the thickness of said first sheet (2) is greatest in correspondence to said second cut (5).

23. A pack (1) according to claim 15, wherein said first sheet (2) is of the type of a laminate comprising at least one bearing layer (7) arranged towards the outside, at least one heat-sealable layer (8) arranged towards said chamber and at least one barrier layer (9) placed between said bearing layer (7) and said heat-sealable layer (8).

24. A pack (1) according to claim 23, wherein said second cut (5) locally involves said heat-sealable layer (8) leaving at least said barrier layer (9) substantially unchanged.

25. A pack (1) according to claim 23, wherein said first sheet (2) comprises two of said barrier layers (9), of which one inner barrier layer (9a) and one outer barrier layer (9b), and comprises at least one intermediate layer (20) placed between said barrier layers (9a, 9b), wherein said first cuts (4) are defined in such a way as to involve at least said outer barrier layer (9b) leaving said inner barrier layer (9a) unchanged and said second cut (5) is such as to involve at least said inner barrier layer (9a) leaving at least said outer barrier layer (9b) unchanged.

26. A pack (1) according to claim 25, wherein said first cuts (4) and said second cut (5) define on the intercepted layers (7, 8, 9, 9a, 9b) respective through cuts.

27. A pack (1) according to claim 20, wherein said first sheet (2) has a decreasing elasticity proceeding from said inner face (2b) towards said outer face (2a).

28. Method for making a single-dose sealed pack (1) with break opening, wherein it comprises the following phases of:
providing at least one bearing layer (7), at least one heat-sealable layer (8) and at least one barrier layer (9);
cutting said bearing layer (7) so as to define two first through cuts (4) in correspondence to its side portions, said first cuts (4) being spaced out from each other in correspondence to the central portion of said bearing layer (7) placed between the relative side portions;
cutting said heat-sealable layer (8) so as to define a second through cut (5) in correspondence to its central portion;
reciprocal solidarization of said layers (7, 8, 9), by superimposing the central portion of said heat-sealable layer (8) over the central portion of said bearing layer (7), to form a first sheet (2) made of semi-rigid plastic material;
solidarization of said first sheet (2) thus obtained to a second sheet (3) made of flexible material so as to define a sealed containment chamber for containing a dose of product.
